(19) United States
(12) Patent Application Publication
(10) Pub. No.: US 2012/0125961 A1
(43) Pub. Date: May 24, 2012

(54) DEPLOYABLE ROOF RACK SYSTEM

(75) Inventor: James G. Gobart, Rochester, MI (US)

(73) Assignee: GM GLOBAL TECHNOLOGY OPERATIONS, INC., Detroit, MI (US)

(21) Appl. No.: 12/949,901

(22) Filed: Nov. 19, 2010

(51) Int. Cl. B60R 9/00

(52) U.S. Cl. 224/321

(57) ABSTRACT

A roof rack system for a vehicle includes a first longitudinal bar and a second longitudinal bar disposed on opposite longitudinal sides of the vehicle. The first longitudinal bar defines a first guide channel, and the second longitudinal bar defines a second guide channel. The first guide channel and the second guide channel guide a transverse bar between a stowed position, wherein the transverse bar is flush with an exterior surface of the roof, and a deployed position, wherein the transverse bar is vertically spaced from the exterior surface of the roof.

### TECHNICAL FIELD

The invention generally relates to a vehicle, and more specifically to a vehicle having a rack system located on an exterior surface of a roof of the vehicle.

### BACKGROUND

Many vehicles include a rack system that is disposed on an exterior surface of a roof of the vehicle. The rack system may be utilized to secure objects, such as luggage, bicycles, canoes, etc. to the roof of the vehicle. Roof rack systems generally include a pair of longitudinally extending bars that are fixedly attached to the roof, and a pair of transverse bars that attach to and extend between the longitudinal bars.

The longitudinal bars and the transverse bars of the rack system are spaced from the exterior surface of the roof to provide space to tie objects thereto. However, because the longitudinal bars and the transverse bars are spaced from the roof, the longitudinal bars and the transverse bars interfere with and disrupt the flow of air over the roof of the vehicle, thereby increasing drag on the vehicle and reducing the fuel efficiency of the vehicle.

### SUMMARY

A vehicle is provided. The vehicle includes a body extending along a longitudinal axis. The body defines a roof having an exterior surface. The vehicle further includes a first longitudinal bar and a second longitudinal bar. The first longitudinal bar extends along the longitudinal axis and away from the exterior surface of the roof. The first longitudinal bar defines a first guide channel. The second longitudinal bar extends along the longitudinal axis and away from the exterior surface of the roof. The second longitudinal bar defines a second guide channel. The first longitudinal bar and the second longitudinal bar are disposed on opposite longitudinal sides of the body with the first guide channel and the second guide channel disposed opposite and facing each other. The vehicle further includes a transverse bar extending between the first longitudinal bar and the second longitudinal bar. The transverse bar includes a first guide member in sliding engagement with the first guide channel, and a second guide member in sliding engagement with the second guide channel. The sliding engagement between the first guide channel and the first guide member, and the second guide channel and the second guide member guides the transverse bar between a deployed position and a stowed position. The transverse bar is vertically spaced from the exterior surface of the roof when in the deployed position, and the transverse bar is substantially flush with the exterior surface of the roof when in the stowed position.

A vehicle is also provided. The vehicle includes a body extending along a longitudinal axis. The body defines a roof having an exterior surface. The vehicle further includes a first longitudinal bar and a second longitudinal bar. The first longitudinal bar extends along the longitudinal axis and away from the exterior surface of the roof. The first longitudinal bar defines a forward first guide channel and a rearward first guide channel. The second longitudinal bar extends along the longitudinal axis and away from the exterior surface of the roof. The second longitudinal bar defines a forward second guide channel and a rearward second guide channel. The first longitudinal bar and the second longitudinal bar are disposed on opposite longitudinal sides of the body. The forward first guide channel and the forward second guide channel are disposed opposite and face each other. The rearward first guide channel and the rearward second guide channel are disposed opposite and facing each other. The vehicle further includes a forward transverse bar and a rearward transverse bar. Each of the forward transverse bar and the rearward transverse bar extend between the first longitudinal bar and the second longitudinal bar, and include a first guide member and a second guide member. The first guide member of the forward transverse bar is in sliding engagement with the forward first guide channel, and the second guide member of the forward transverse bar is in sliding engagement with the forward second guide channel. The first guide member of the rearward transverse bar is in sliding engagement with the rearward first guide channel, and the second guide member of the rearward transverse bar is in sliding engagement with the rearward second guide channel. The vehicle further includes an actuator coupled to the transverse bar. The actuator is configured for moving the transverse bar between a stowed position and a deployed position. The forward first guide channel and the forward second guide channel guide the forward transverse bar, and the rearward first guide channel and the rearward second guide channel guide the rearward transverse bar between the deployed position and the stowed position. The forward transverse bar and the rearward transverse bar are vertically spaced from the exterior surface of the roof when in the deployed position. The forward transverse bar and the rearward transverse bar are substantially flush with the exterior surface of the roof when in the stowed position.

A vehicle is also provided. The vehicle includes a body extending along a longitudinal axis. The body defines a roof having an exterior surface. A first longitudinal bar extends along the longitudinal axis and away from the exterior surface of the roof. The first longitudinal bar defines a forward first guide channel and a rearward first guide channel. A second longitudinal bar extends along the longitudinal axis and away from the exterior surface of the roof. The second longitudinal bar defines a forward second guide channel and a rearward second guide channel. The first longitudinal bar and the second longitudinal bar are disposed on opposite longitudinal sides of the body with the forward first guide channel and the forward second guide channel disposed opposite and facing each other, and the rearward first guide channel and the rearward second guide channel disposed opposite and facing each other. A forward transverse bar and a rearward transverse bar each extend between the first longitudinal bar and the second longitudinal bar. The forward transverse bar and the rearward transverse bar each include a first guide member and a second guide member. The first guide member of the forward transverse bar is in sliding engagement with the forward first guide channel, and the second guide member of the forward transverse bar is in sliding engagement with the forward second guide channel. The first guide member of the rearward transverse bar is in sliding engagement with the rearward first guide channel, and the second guide member of the rearward transverse bar is in sliding engagement with the rearward second guide channel. An actuator is coupled to the transverse bar. The actuator is configured for moving the transverse bar between a stowed position and a deployed position. The forward first guide channel and the forward second guide channel guide the forward transverse bar between the deployed position and the stowed position. The rearward first guide channel and the rearward second guide channel guide the rearward transverse bar between the deployed position and the stowed position. The forward transverse bar and the rearward transverse bar are vertically spaced from the exterior surface of the roof when in the deployed position. The forward transverse bar and the rearward transverse bar are substantially flush with the exterior surface of the roof when in the stowed position. The forward transverse bar and the rearward transverse bar are attached together, and are vertically and horizontally moveable relative to the first longitudinal bar and the second longitudinal bar for simultaneous movement between the deployed position and the stowed position. Each of the forward first guide channel, the rearward first guide channel, the forward second guide channel and the rearward second guide channel include an angled portion and a horizontal portion. The horizontal portion is vertically spaced from the exterior surface of the roof. The angled portion extends from adjacent the exterior surface of the roof to the horizontal portion, and defines an acute internal angle relative to the exterior surface of the roof. The roof defines a forward transverse channel and a rearward transverse channel, each extending transversely across the roof relative to the longitudinal axis between the first longitudinal bar and the second longitudinal bar. The forward transverse bar is disposed within the forward transverse channel when in the stowed position. The rearward transverse bar is disposed within the rearward transverse channel when in the stowed position.

Accordingly, the transverse bars may be positioned in the stowed position when not in use. When in the stowed position, the transverse bars are disposed flush with the exterior surface of the roof, and therefore do not interfere with or disrupt the aerodynamics of the vehicle, thereby improving the fuel efficiency of the vehicle. When needed to secure objects to the roof, the transverse bars may be moved into the deployed position, thereby allowing the objects to be tied down to the transverse bars.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a vehicle showing an exploded view of a roof rack system of the vehicle.

FIG. 2 is a schematic perspective view of the vehicle showing the roof rack system in a stowed position.

FIG. 3 is a schematic side cross sectional view of the vehicle showing the roof rack system in the stowed position.

FIG. 4 is a schematic perspective view of the vehicle showing the roof rack system in a deployed position.

FIG. 5 is a schematic side cross sectional view of the vehicle showing the roof rack system in the deployed position.

FIG. 6 is an enlarged schematic cross sectional view showing a guide channel of the roof rack system.

### DETAILED DESCRIPTION

Referring to the Figures, wherein like numerals indicate like parts throughout the several views, a vehicle is shown generally at 20. The vehicle 20 may include any style and/or size of vehicle 20 including but not limited to a passenger car, a sport utility vehicle 20 or a van.

While the present invention is described in detail with respect to automotive applications, those skilled in the art will recognize the broader applicability of the invention. Those having ordinary skill in the art will also recognize that terms such as “above,” “below,” “upward,” “downward,” “forward,” “rearward,” et cetera, are used descriptively of the figures, and do not represent limitations on the scope of the invention, as defined by the appended claims.

Referring to FIG. 1, the vehicle 20 includes a body 22. The body 22 extends along a longitudinal axis 24, and includes a first end 26 and a second end 28 disposed at opposite ends of the vehicle 20 along the longitudinal axis 24. As shown, the first end 26 is a forward end of the vehicle 20, and the second end 28 is a rearward end of the vehicle 20. However, it should be appreciated that the relative positions of the first end 26 and the second end 28 may be reversed.

The body 22 defines a roof 30. The roof 30 may include the uppermost portion of the body 22. However, the roof 30 should be interpreted to include any generally horizontal portion 70 of the vehicle 20. The roof 30 includes an exterior surface 32, and defines a transverse channel 34, 36. The transverse channel 34, 36 extends transversely across the roof 30 relative to the longitudinal axis 24 of the body 22. As shown, the transverse channel 34, 36 includes a forward transverse channel 34 and a rearward transverse channel 36 spaced from and parallel with the forward transverse channel 34. The forward transverse channel 34 is disposed nearer the first end 26 of the vehicle 20 than the rearward transverse channel 36. It should be appreciated that the vehicle 20 may define any number of transverse channels.

The vehicle 20 includes a roof rack system 38. The roof rack system 38 includes a first longitudinal bar 40 and a second longitudinal bar 42. The first longitudinal bar 40 and the second longitudinal bar 42 are fixedly secured and immobile relative to the roof 30. The first longitudinal bar 40 extends along the longitudinal axis 24 and away from the exterior surface 32 of the roof 30. The second longitudinal bar 42 also extends along the longitudinal axis 24 and away from the exterior surface 32 of the roof 30. The first longitudinal bar 40 and the second longitudinal bar 42 are disposed on opposite longitudinal sides of the body 22.

The first longitudinal bar 40 defines a first guide channel 44, 46. As shown, the first guide channel 44, 46 may include a forward first guide channel 44 and a rearward first guide channel 46. The second longitudinal bar 42 defines a second guide channel 48, 50. As shown, the second guide channel 48, 50 may include a forward second guide channel 48 and a rearward second guide channel 50. It should be appreciated that the first guide channel 44, 46 and the second guide channel 48, 50 may include any number of guide channels. The first guide channel 44, 46 and the second guide channel 48, 50 are mirror images of each other across the longitudinal axis 24 of the body 22. The first guide channel 44, 46 and the second guide channel 48, 50 are disposed opposite each other and face each other. As shown, the forward first guide channel 44 is disposed opposite and faces the forward second guide channel 48, and the rearward first guide channel 46 is disposed opposite and faces the rearward second guide channel 50.

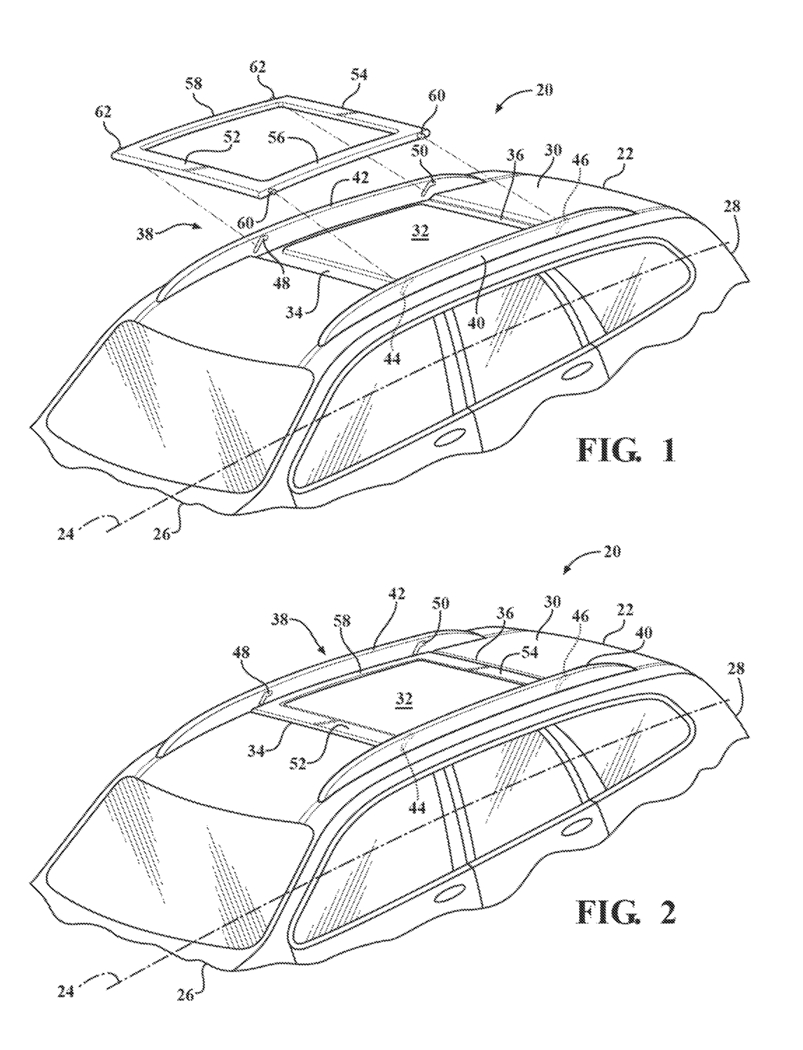

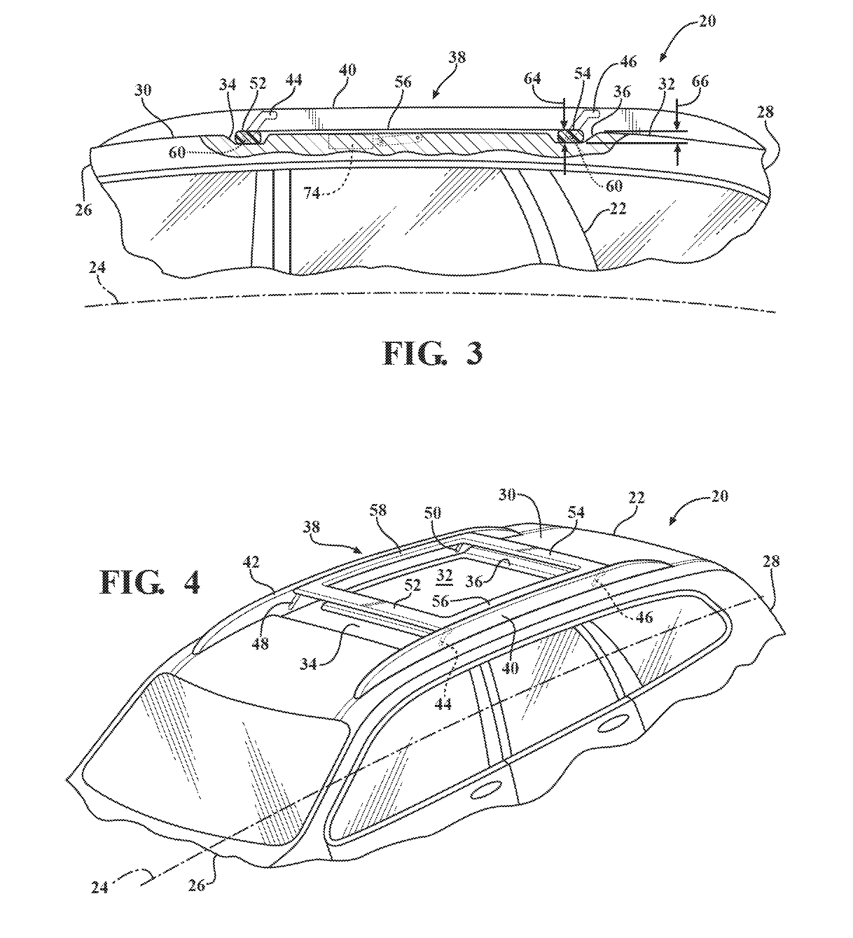

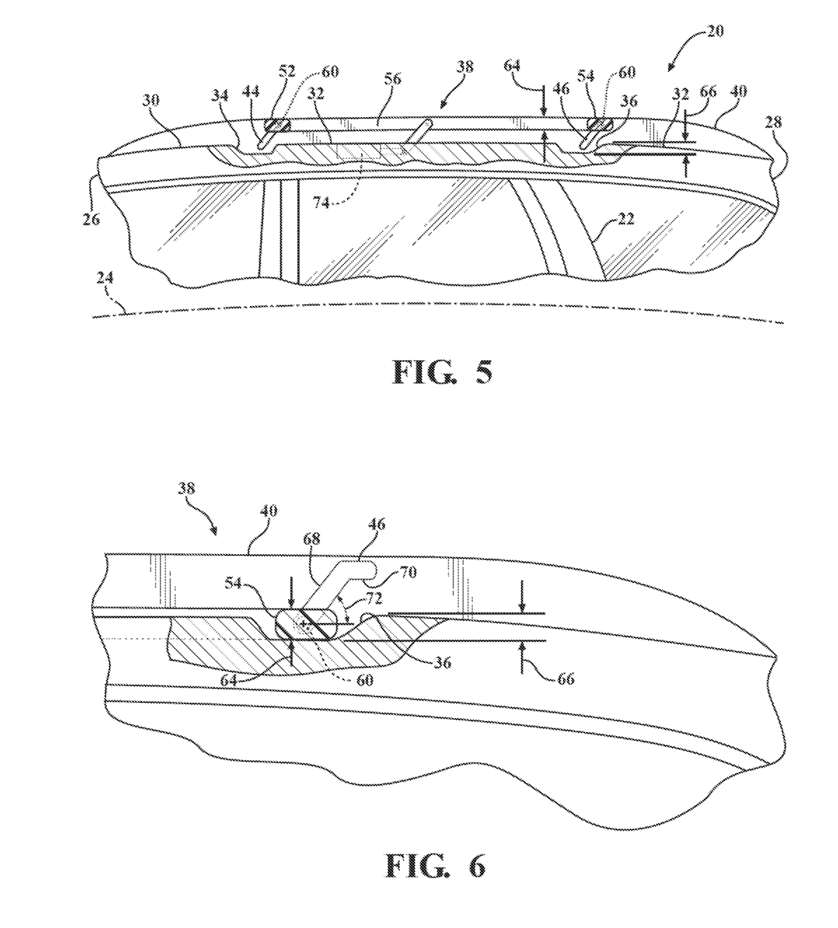

The roof rack system 38 further includes a transverse bar 52, 54. As shown, the transverse bar 52, 54 includes a forward transverse bar 52 and a rearward transverse bar 54. However, it should be appreciated that the transverse bar 52, 54 may include any number of bars. The transverse bar 52, 54, including both the forward transverse bar 52 and the rearward transverse bar 54, extends between the first longitudinal bar 40 and the second longitudinal bar 42. The forward transverse bar 52 and the rearward transverse bar 54 are attached together for simultaneous movement between a stowed position, shown in FIGS. 2 and 3, and a deployed position, shown in FIGS. 4 and 5. For example, a first link 56 and a second link 58 may interconnect the forward transverse bar 52 and the rearward transverse bar 54 to define a rigid framework. However, it should be appreciated that the forward transverse bar 52 and rearward transverse bar 54 may be attached together in some other manner.

Each of the forward transverse bar 52 and the rearward transverse bar 54 include a first guide member 60 and a second guide member 62. The first guide member 60 is in sliding engagement with the first guide channel 44, and the second guide member 62 in sliding engagement with the second guide channel 48. As shown, the first guide member 60 of the forward transverse bar 52 is in sliding engagement with the forward first guide channel 44 of the first longitudinal bar 40, and the second guide member 62 of the forward transverse bar 52 is in sliding engagement with the forward second guide channel 48 of the second longitudinal bar 42. Similarly, the first guide member 60 of the rearward transverse bar 54 is in sliding engagement with the rearward first guide channel 46 of the first longitudinal bar 40, and the second guide member 62 of the rearward transverse bar 54 is in sliding engagement with the rearward second guide channel 50 of the second longitudinal bar 42.

The sliding engagement between the first guide channels 44, 46 and the first guide members 60, and the second guide channels 48, 50 and the second guide members 62 guide the transverse bars 52, 54 between the deployed position and the stowed position. More specifically, the forward first guide channel 44 and the forward second guide channel 48 guide the forward transverse bar 52, and the rearward first guide channel 46 and the rearward second guide channel 50 guide the rearward transverse bar 54. The transverse bars 52, 54 are vertically spaced from the exterior surface 32 of the roof 30 when in the deployed position. The transverse bars 52, 54 are substantially flush with the exterior surface 32 of the roof 30 when in the stowed position. The transverse bars 52, 54 are vertically and horizontally moveable relative to the first longitudinal bar 40 and the second longitudinal bar 42 when moving between the deployed position and the stowed position.

The forward transverse channel 34 and the rearward transverse channel 36 (described above) extend transversely across the roof 30 relative to the longitudinal axis 24, between the first longitudinal bar 40 and the second longitudinal bar 42. The forward transverse bar 52 is disposed within the forward transverse channel 34 when in the stowed position. Similarly, the rearward transverse bar 54 is disposed within the rearward transverse channel 36 when in the stowed position.

As best shown in FIG. 6, each of the transverse bars 52, 54 includes a thickness 64, and each of the transverse channels 34, 36 extends a vertical depth 66 below the exterior surface 32 of the roof 30. The thickness 64 of the transverse bars 52, 54 is substantially equal to the vertical depth 66 of the transverse channel 34, 36. Accordingly, when the transverse bars 52, 54 are disposed in the transverse channels 34, 36, the transverse bars 52, 54 are substantially flush with the exterior surface 32 of the roof 30, thereby minimizing aerodynamic drag on the vehicle 20, and increasing fuel efficiency of the vehicle 20.

The forward first guide channel 44, the rearward first guide channel 46, the forward second guide channel 48 and the rearward second guide channel 50 each include an angled portion 68 and a horizontal portion 70. The horizontal portion 70 is vertically spaced from the exterior surface 32 of the roof 30. The angled portion 68 extends from adjacent the exterior surface 32 of the roof 30 vertically upward to the horizontal portion 70. The angled portion 68 of the guide channels 44, 46, 48, 50 defines an acute internal angle 72 relative to the exterior surface 32 of the roof 30. For example, the acute internal angle 72 may include an angle less than sixty degrees (60°). More specifically, the acute internal angle 72 may include an angle less than forty five degrees) (45°. However, it should be appreciated that the internal angle 72 may be greater than the sixty degrees (60°) described above. When moving from the stowed position to the deployed position, the angle of the internal angle 72 directs the transverse bars 52, 54 along a path that is both vertically upward and longitudinally rearward, while the horizontal portion 70 of the guide channels 44, 46, 48, 50 directs the transverse bars 52, 54 longitudinally rearward. When moving from the deployed position to the stowed position, the horizontal portion 70 of the guide channels 44, 46, 48, 50 directs the transverse bars 52, 54 longitudinally forward, while the angle of the internal angle 72 directs the transverse bars 52, 54 along a path that is both vertically downward and longitudinally forward. The value of the internal angle 72 determines the rate of vertical movement relative to the longitudinal movement, as well as the amount of power required to move the transverse bars 52, 54 between the stowed position and the deployed position. A steeper, higher value of the internal angle 72 requires more power to move the transverse bars 52, 54, but moves them vertically more quickly. A slacker, lower value of the internal angle 72 requires less power to move the transverse bars 52, 54, but moves them vertically more slowly.

As shown in FIGS. 3 and 5, the roof rack system 38 may further include an actuator 74 coupled to one or both of the transverse bars 52, 54. The actuator 74 is configured for moving the transverse bars 52, 54 between the stowed position and the deployed position. The actuator 74 may include but is not limited to a motor, such as an electric motor or the like. The actuator 74 may further include any linkages, connections, gears, or other components necessary to couple the motor to the transverse bars 52, 54 and move the transverse bars 52, 54 between the stowed position and the deployed position. The actuator 74 is sufficiently sized to move the transverse bars 52, 54 up the angled portion 68 of the guide channels 44, 46, 48, 50.

While the best modes for carrying out the invention have been described in detail, those familiar with the art to which this invention relates will recognize various alternative designs and embodiments for practicing the invention within the scope of the appended claims.

1. A vehicle comprising:
a body extending along a longitudinal axis and defining a roof having an exterior surface;
a first longitudinal bar extending along the longitudinal axis and away from the exterior surface of the roof, the first longitudinal bar defining a first guide channel;
a second longitudinal bar extending along the longitudinal axis and away from the exterior surface of the roof, the second longitudinal bar defining a second guide channel, wherein the first longitudinal bar and the second longitudinal bar are disposed on opposite longitudinal sides of the body with the first guide channel and the second guide channel disposed opposite and facing each other; and
a transverse bar extending between the first longitudinal bar and the second longitudinal bar and including a first guide member in sliding engagement with the first guide channel and a second guide member in sliding engagement with the second guide channel,
wherein the sliding engagement between the first guide channel and the first guide member and the second guide channel and the second guide member guides the transverse bar between a deployed position and a stowed position, with the transverse bar vertically spaced from the exterior surface of the roof when in the deployed position, and the transverse bar substantially flush with the exterior surface of the roof when in the stowed position.

2. A vehicle as set forth in claim 1 wherein each of the first guide channel and the second guide channel include an angled portion and a horizontal portion, wherein the horizontal portion is vertically spaced from the exterior surface of the roof, and wherein the angled portion extends from adjacent the exterior surface of the roof to the horizontal portion and defines an acute internal angle relative to the exterior surface of the roof.

3. A vehicle as set forth in claim 2 wherein the acute internal angle is less than sixty degrees (60°).

4. A vehicle as set forth in claim 3 wherein the acute internal angle is less than forty five degrees (45°).

5. A vehicle as set forth in claim 2 wherein the first guide channel and the second guide channel are mirror images of each other.

6. A vehicle as set forth in claim 5 wherein the transverse bar is vertically and horizontally moveable relative to the first longitudinal bar and the second longitudinal bar when moving between the deployed position and the stowed position.

7. A vehicle as set forth in claim 1 wherein the roof defines a transverse channel extending transversely across the roof relative to the longitudinal axis between the first longitudinal bar and the second longitudinal bar, with the transverse bar disposed within the transverse channel when in the stowed position.

8. A vehicle as set forth in claim 7 wherein the transverse bar includes a thickness and the transverse channel extends a vertical depth below the exterior surface of the roof, wherein the thickness of the transverse bar is substantially equal to the vertical depth of the transverse channel.

9. A vehicle as set forth in claim 1 further comprising an actuator coupled to the transverse bar and configured for moving the transverse bar between the stowed position and the deployed position.

10. A vehicle as set forth in claim 9 wherein the actuator includes an electric motor.

11. A vehicle as set forth in claim 1 wherein the first guide channel includes a forward first guide channel and a rearward first guide channel, the second guide channel includes a forward second guide channel and a rearward second guide channel, and the transverse bar includes a forward transverse bar and a rearward transverse bar, wherein the forward first guide channel and the forward second guide channel guide the forward transverse bar, and the rearward first guide channel and the rearward second guide channel guide the rearward transverse bar.

12. A vehicle as set forth in claim 11 wherein the forward transverse bar and the rearward transverse bar are attached together for simultaneous movement between the deployed position and the stowed position.

13. A vehicle comprising:
a body extending along a longitudinal axis and defining a roof having an exterior surface;
a first longitudinal bar extending along the longitudinal axis and away from the exterior surface of the roof, the first longitudinal bar defining a forward first guide channel and a rearward first guide channel;
a second longitudinal bar extending along the longitudinal axis and away from the exterior surface of the roof, the second longitudinal bar defining a forward second guide channel and a rearward second guide channel, wherein the first longitudinal bar and the second longitudinal bar are disposed on opposite longitudinal sides of the body with the forward first guide channel and the forward second guide channel disposed opposite and facing each other, and the rearward first guide channel and the rearward second guide channel disposed opposite and facing each other;
a forward transverse bar and a rearward transverse bar each extending between the first longitudinal bar and the second longitudinal bar and including a first guide member and a second guide member, wherein the first guide member of the forward transverse bar is in sliding engagement with the forward first guide channel and the second guide member of the forward transverse bar is in sliding engagement with the forward second guide channel, and wherein the first guide member of the rearward transverse bar is in sliding engagement with the rearward first guide channel and the second guide member of the rearward transverse bar is in sliding engagement with the rearward second guide channel; and
an actuator coupled to the transverse bar and configured for moving the transverse bar between a stowed position and a deployed position;
wherein the forward first guide channel and the forward second guide channel guide the forward transverse bar between the deployed position and the stowed position, and the rearward first guide channel and the rearward second guide channel guide the rearward transverse bar between the deployed position and the stowed position, and
wherein the forward transverse bar and the rearward transverse bar vertically spaced from the exterior surface of the roof when in the deployed position, and the forward transverse bar and the rearward transverse bar substantially flush with the exterior surface of the roof when in the stowed position.

14. A vehicle as set forth in claim 13 wherein the forward transverse bar and the rearward transverse bar are attached together for simultaneous movement between the deployed position and the stowed position.

15. A vehicle as set forth in claim 13 wherein the forward transverse bar and the rearward transverse bar are vertically and horizontally moveable relative to the first longitudinal bar and the second longitudinal bar when moving between the deployed position and the stowed position.

16. A vehicle as set forth in claim 13 wherein each of the forward first guide channel, the rearward first guide channel, the forward second guide channel and the rearward second guide channel include an angled portion and a horizontal portion, wherein the horizontal portion is vertically spaced from the exterior surface of the roof, and wherein the angled portion extends from adjacent the exterior surface of the roof to the horizontal portion and defines an acute internal angle relative to the exterior surface of the roof.

17. A vehicle as set forth in claim 16 wherein the acute internal angle is less than sixty degrees (60°).

18. A vehicle as set forth in claim 13 wherein the forward first guide channel and the forward second guide channel are mirror images of each other, and wherein the rearward first guide channel and the rearward second guide channel are mirror images of each other.

19. A vehicle as set forth in claim 13 wherein the roof defines a forward transverse channel and a rearward transverse channel each extending transversely across the roof relative to the longitudinal axis between the first longitudinal bar and the second longitudinal bar, with the forward transverse bar disposed within the forward transverse channel when in the stowed position, and the rearward transverse bar disposed within the rearward transverse channel when in the stowed position.

20. A vehicle comprising:
a body extending along a longitudinal axis and defining a roof having an exterior surface;
a first longitudinal bar extending along the longitudinal axis and away from the exterior surface of the roof, the first longitudinal bar defining a forward first guide channel and a rearward first guide channel;
a second longitudinal bar extending along the longitudinal axis and away from the exterior surface of the roof, the second longitudinal bar defining a forward second guide channel and a rearward second guide channel, wherein the first longitudinal bar and the second longitudinal bar are disposed on opposite longitudinal sides of the body with the forward first guide channel and the forward second guide channel disposed opposite and facing each other, and the rearward first guide channel and the rearward second guide channel disposed opposite and facing each other;
a forward transverse bar and a rearward transverse bar each extending between the first longitudinal bar and the second longitudinal bar and including a first guide member and a second guide member, wherein the first guide member of the forward transverse bar is in sliding engagement with the forward first guide channel and the second guide member of the forward transverse bar is in sliding engagement with the forward second guide channel, and wherein the first guide member of the rearward transverse bar is in sliding engagement with the rearward first guide channel and the second guide member of the rearward transverse bar is in sliding engagement with the rearward second guide channel; and
an actuator coupled to the transverse bar and configured for moving the transverse bar between the stowed position and the deployed position;
wherein the forward first guide channel and the forward second guide channel guide the forward transverse bar between a deployed position and a stowed position, and the rearward first guide channel and the rearward second guide channel guide the rearward transverse bar between the deployed position and the stowed position,
wherein the forward transverse bar and the rearward transverse bar vertically spaced from the exterior surface of the roof when in the deployed position, and the forward transverse bar and the rearward transverse bar substantially flush with the exterior surface of the roof when in the stowed position;
wherein the forward transverse bar and the rearward transverse bar are attached together and are vertically and horizontally moveable relative to the first longitudinal bar and the second longitudinal bar for simultaneous movement between the deployed position and the stowed position;
wherein each of the forward first guide channel, the rearward first guide channel, the forward second guide channel and the rearward second guide channel include an angled portion and a horizontal portion, wherein the horizontal portion is vertically spaced from the exterior surface of the roof, and wherein the angled portion extends from adjacent the exterior surface of the roof to the horizontal portion and defines an acute internal angle relative to the exterior surface of the roof; and
wherein the roof defines a forward transverse channel and a rearward transverse channel each extending transversely across the roof relative to the longitudinal axis between the first longitudinal bar and the second longitudinal bar, with the forward transverse bar disposed within the forward transverse channel when in the stowed position, and the rearward transverse bar disposed within the rearward transverse channel when in the stowed position.
